(19) United States
(12) Patent Application Publication
(10) Pub. No.: US 2024/0172109 A1
(43) Pub. Date: May 23, 2024

(54) CALL PERFORMANCE OPTIMIZATION

(71) Applicant: AT&T Intellectual Property I, L.P., Atlanta, GA (US)

(72) Inventors: Catherine Kalke, Seattle, WA (US); Prabhakara Aithal, Austin, TX (US); William Rosenberg, Austin, TX (US); Jinhong No, Issaquah, WA (US)

(21) Appl. No.: 18/166,242

(22) Filed: Feb. 8, 2023

Related U.S. Application Data
(60) Provisional application No. 63/426,220, filed on Nov. 17, 2022.

(51) Int. Cl. H04W 48/20; H04W 24/02

(52) U.S. Cl. CPC H04W 48/20; H04W 24/02

(57) ABSTRACT

A processing system of a user endpoint device including at least one processor may initiate an audio call for the user endpoint device at a location, select a wireless access point type from among a plurality of wireless access point types for the audio call based on at least one of: performance metrics collected by the user endpoint device at the location or performance metrics for the location obtained by the user endpoint device from a remote database, and implement the audio call via the wireless access point type that is selected.

This application claims priority to U.S. Provisional Application Ser. No. 63/426,220 (“CALL PERFORMANCE OPTIMIZATION”), filed Nov. 17, 2022, which is incorporated herein by reference.

The present disclosure relates generally to call optimization systems, and more particularly to methods, computer-readable media, and apparatuses for optimizing audio performance for a call, e.g., a Wi-Fi call.

### BACKGROUND

Current trends in wireless technology prefer the use of a radio access network/radio access technology (RAN/RAT) access point as a default instead of a Wi-Fi access point. This preference is based on the notion that Wi-Fi is a best-effort service when compared to the guaranteed bit-rate QoS (Quality of Service) available on the radio access network. However, in practice, at any given time during an audio call, the audio call performance may be better on one access technology versus the other access technology. This dynamic nature as to the performance of the various access technologies (e.g., RAN bearer or Wi-Fi bearer) presents a challenge in providing a satisfying experience to users.

### SUMMARY

In one example, the present disclosure describes a method, computer-readable medium, and apparatus for optimizing audio performance for a call, e.g., via a machine learning algorithm. For instance, in one example, a processing system of a user endpoint device including at least one processor may initiate an audio call for the user endpoint device at a location, select a wireless access point type from among a plurality of wireless access point types for the audio call based on at least one of: performance metrics collected by the user endpoint device at the location or performance metrics for the location obtained by the user endpoint device from a remote database, and implement the audio call via the wireless access point type that is selected.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates a flowchart of an example method for optimizing audio performance for a call; and

FIG. 3 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

The quality of an audio call can be determined by specific QoS parameters including packet loss, latency, and/or jitter. In one example, Real Time Transport Protocol (RTP) Control Protocol (RTCP) may provide real-time statistics on the audio quality (e.g., packet loss, jitter, and/or latency) during an audio call, however it is an end-to-end measurement between two devices (e.g., between a Device A and a Device B). The user/device cannot tell if the audio quality issues are due to the local radio link or are due to problems with the other party's device. Thus, a device could end up triggering a handoff from a Wi-Fi access point to the RAN/RAT access point based on RTCP but may end up on a worse performing RAT. This means that the audio quality issues of an audio call will persist for the duration of the audio call.

Examples of the present disclosure describe methods, computer-readable media, and apparatuses for optimizing audio performance for a call. In particular, examples of the present disclosure deploy a local optimization module or engine in a user endpoint device. In one embodiment, the local optimization module or engine may further employ a machine learning algorithm (MLA) (e.g., an artificial intelligence algorithm (AIA)) to assist in dynamically assessing the quality of an audio call (e.g., to ensure the user endpoint device is using the higher quality bearer for the audio call). In one embodiment, the user endpoint device could collect learnings (e.g., historical information and patterns) for specific device locations and any previously connected Wi-Fi access points and determine whether the RAN bearer or Wi-Fi bearer at the specific location will provide a better audio call performance (e.g., at a particular time of the day, at a particular day of the week, at a particular month or time of a year, etc.). For example, even if the initial setup or handoff decision (i.e., based on signal strength or Real Time Transport Protocol (RTP) Control Protocol (RTCP)) provided a worse call quality, the local optimization module or engine (e.g., MLA/AIA engine) could continually learn from this initial setup or handoff decision and may optimize the handoff decisions for each location over time (e.g., for a future call setup).

In one embodiment, the user endpoint device may deploy the local optimization module or engine (e.g., an MLA/AIA module or engine) to collect local audio performance measurements for a local location (e.g., jitter, latency, and/or packet loss). This audio performance measurements can be stored locally in a local database within the user endpoint device for its own internal use. However, in one embodiment, the user endpoint device provides this audio performance measurements to a Master Database (e.g., located in a network, e.g., a network service provider network). This uploading of the audio performance measurements allows the Master Database to receive and aggregate a large amount of audio performance measurements from a plurality of user endpoint devices from a plurality of different locations. This, in turns, allows the Master Database to disseminate aggregated performance metrics of a Wi-Fi access point versus a RAT access point on a per location basis to any requesting user endpoint device (e.g., on a per request basis (instantaneous update) or a subscription basis (continuous periodic updates)). This access to the Master Database allows the user endpoint device (e.g., the MLA/AIA Engine) to dynamically identify the name of the location (e.g., the nearest Wi-Fi access point, nearest RAT access point, and the like) and the specific audio performance measurements for that specific location (e.g., jitter, latency, and/or packet loss). This allows the user endpoint device to use this real time information to make an appropriate decision in selecting the most appropriate access point technology for setting up the audio call and/or offloading the audio call to a different access point technology while the audio call is still active for a specific geographic location.

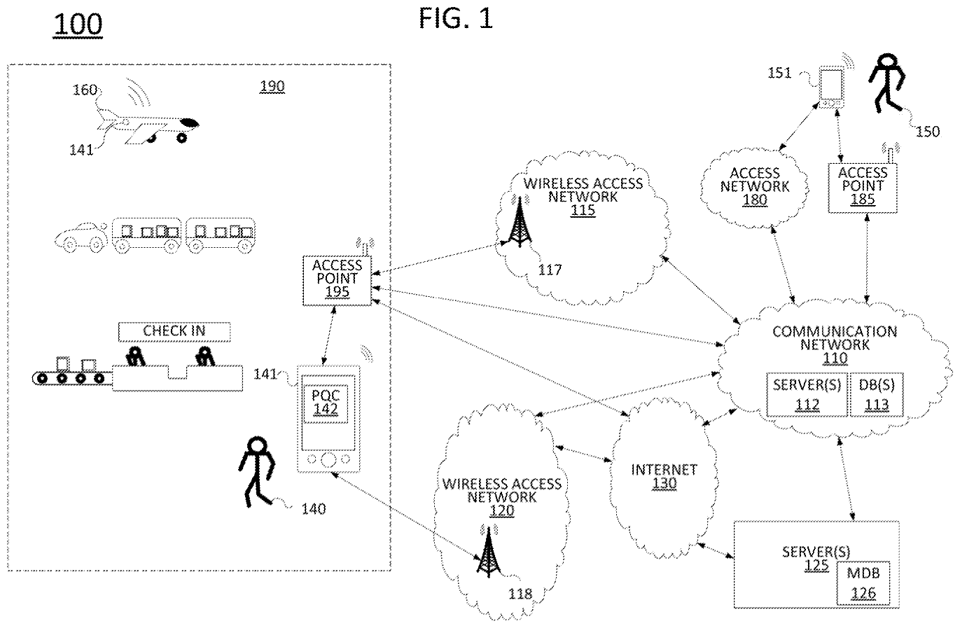

One beneficial aspect of the present disclosure is that end users may actually experience less or minimal performance degradation in the audio quality during a Wi-Fi call (WFC) when connected to a specific Wi-Fi access point instead of a RAN access point. End users connected to a roaming network will be able to make efficient use of WFC to avoid roaming charges. Furthermore, if the local optimization module or engine is implemented in a chipset for deployment in a user endpoint device (e.g., a smart phone, a smart headset, a smart wearable device, and the like), the chipset manufacturer may monetize the use of the MLA/AIA engine to implement machine learning for audio performance optimization during Wi-Fi calls. These and other aspects of the present disclosure are discussed in greater detail below in connection with the examples of FIGS. 1-3.

To aid in understanding the present disclosure, FIG. 1 illustrates an example system 100, related to the present disclosure. As shown in FIG. 1, the system 100 connects user endpoint device 141, server(s) 112, database(s) (DB(s)) 113, server(s) 125, access point 195 (e.g., a Wi-Fi access point), and so forth with one another and with various other devices via a core network, e.g., a communication network 110, wireless access networks 115 and 120 (e.g., a cellular network, or cellular networks (e.g., cellular access networks)), and Internet 130.

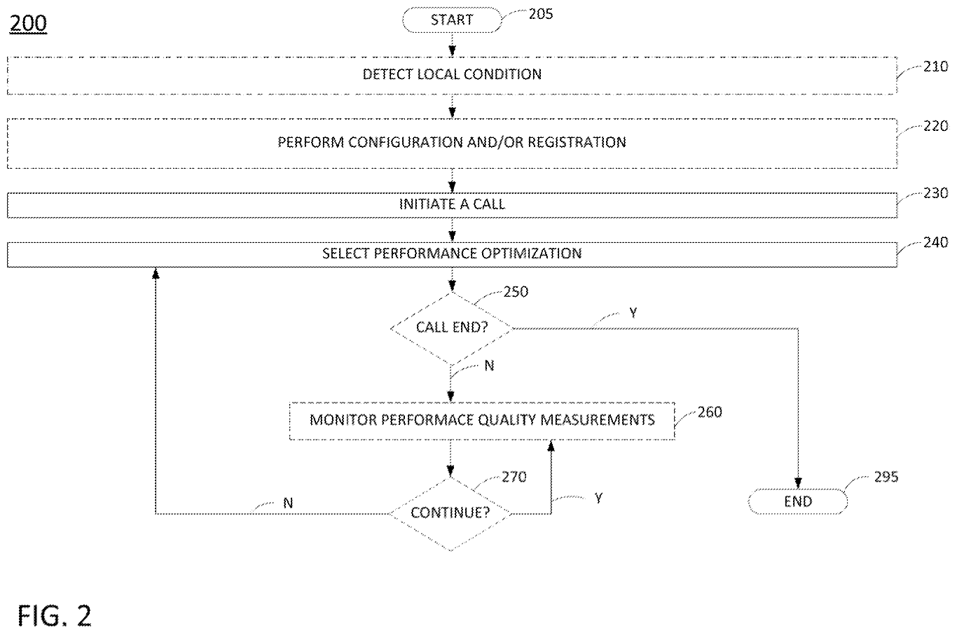

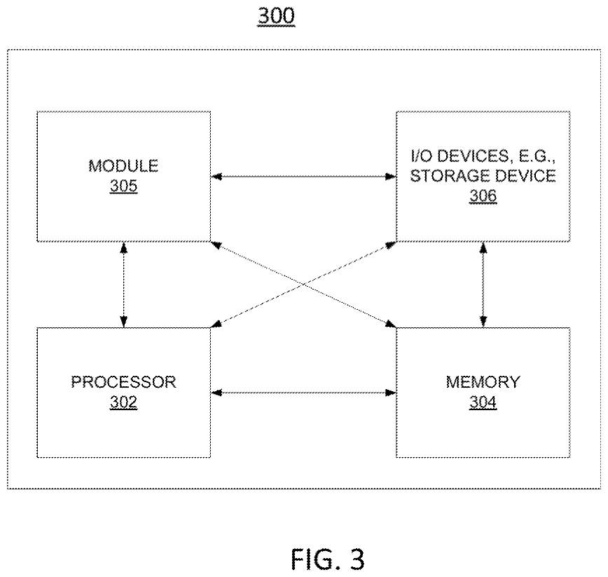

In one example, the server(s) 125 may each comprise a computing device or processing system, such as computing system 300 depicted in FIG. 3, and may be configured to perform one or more steps, functions, or operations in connection with examples of the present disclosure for optimizing audio performance for a call. For instance, an example method for optimizing audio performance for a call, e.g., via a machine learning algorithm is illustrated in FIG. 2 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 3 and discussed below) or multiple computing devices collectively configured to perform various steps, functions, and/or operations in accordance with the present disclosure.

In one example, server(s) 112 and/or server(s) 125 may comprise, or be coupled to or in communication with a DB(s) 113 and Master Database (DB) 126, respectively and may also employ a machine learning model (MLM) to process received performance metrics. For instance, the server(s) 112, or server(s) 125 may assist in optimizing audio performance for a call. FIG. 1 illustrates that this assistance may originate from the network service provider network 110 or may originate from an external server 125 (e.g., operated by a third party service provider independent from the network service provider of communication network 110). In other words, the Master Database (DB) can be deployed within the communication network 110 (e.g., within DB(s) 113) or external to the communication network 110 (e.g., within MDB 126).

In one example, database(s) 113 and/or MDB 126 may represent one or more distributed file systems, e.g., a Hadoop® Distributed File System (HDFS™) or the like. Server(s) 112 and/or 125 may receive and store information regarding audio performance measurements received from a plurality of user endpoint devices.

In one example, the system 100 includes a communication network 110. In one example, communication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the communication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

As shown in FIG. 1, communication network 110 may also include one or more servers 112. In one example, each of the server(s) 112 may comprise a computing device or processing system, such as computing system 300 depicted in FIG. 3 and may be configured to provide one or more functions in connection with examples of the present disclosure for optimizing audio performance for a call, e.g., via a machine learning algorithm. For example, one or more of the server(s) 112 may be configured to perform one or more steps, functions, or operations in connection with the example method 200 described below. In one example, server(s) 112 may perform the same or similar functions as server(s) 125. For instance, communication network 110 may provide a management system, e.g., as a service to one or more subscribers/customers, in addition to telephony services, data communication services, television services, etc. For ease of illustration, various additional elements of telecommunication network 110 are omitted from FIG. 1.

In one example, one or more wireless access networks 115 and 120 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 and 120 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, user endpoint device 141 of user 140 may be in communication with base station 118 and/or access point 195, which provide connectivity between user endpoint device 141, and other endpoint devices (e.g., user endpoint device 151 of user 150) within the system 100, various network-based devices, such as server(s) 112, server(s) 125, and so forth. In one example, wireless access network(s) 115 and/or 120 may be operated by the same service provider that is operating communication network 110, or one or more other service providers. For instance, communication network 110 may comprise a cellular core network. Similarly, user endpoint device 151 may be connected to various other endpoint devices, network-based devices, etc. via access network 180 (e.g., a cellular access network and/or via access point 185, which may be of a same or similar nature as access point 195).

As illustrated in FIG. 1, user endpoint device 141 may comprise, for example, a cellular telephone, a smartphone, a tablet computing device, a laptop computer, a desktop computer, a wireless enabled wristwatch, or any other wireless and/or cellular-capable mobile telephony and computing devices (broadly, a “mobile device” or “mobile endpoint device”). In one example, user endpoint device 141 may be equipped for cellular and non-cellular wireless communication. For instance, user endpoint device 141 may include components which support peer-to-peer and/or short range wireless communications, e.g., IEEE 802.11 based communications (e.g., Wi-Fi, Wi-Fi Direct), IEEE 802.15 based communications (e.g., Bluetooth, Bluetooth Low Energy (BLE), and/or ZigBee communications), LTE Direct, Dedicated Short Range Communications (DSRC), e.g., in the 5.9 MHz band, or the like, a 5G device-to-device (D2D) sidelink, such as over a P5 interface, and so forth. For instance, user endpoint device 141 may include one or more radio frequency (RF) transceivers, e.g., for cellular communications and/or for non-cellular wireless communications. In one example, user endpoint device 141 may comprise a computing device or processing system, such as computing system 300 depicted in FIG. 3, and may be configured to perform one or more steps, functions, or operations for optimizing audio performance for a call via a performance quality controller (PQC) 142 (or a performance quality chipset). For instance, an example method for optimizing audio performance for a call, e.g., via a machine learning algorithm is illustrated in FIG. 2 and described below.

In the present example, access point 195 may be associated with a transit location, e.g., an airport 190. For instance, access point 195 may be a wireless access point (e.g., a Wi-Fi access point) of a local network provided by the airport 190. In one example, access point 195 may establish communications with user endpoint device 141 and may provide connectivity for user endpoint device 141 to Internet 130, communication network 110, devices or system accessible via such networks (e.g., server(s) 112, 125, etc.), and so on.

In an illustrative example, a user 140 having user endpoint device 141 may be commencing a trip via airport 190 to board airplane 160. In one example, the user 140 may permit a travel-related system to communicate with the user endpoint device 141 to provide a pertinent itinerary. For instance, the user endpoint device 141 may provide an identifier to an automated online system of the airline in designated or expected format, such as via an Extensible Markup Language (XML) schema, a Java Script Object Notation (JSON) object, or the like.

In one embodiment, user endpoint device 141 may also deploy one or more machine learning models (MLMs) associated with optimizing audio performance for a call. For instance, user endpoint device 141 may obtain one or more MLMs from server(s) 112 or 125 that are stored in a machine learning model (MLM) database (DB) (e.g., one of DB(s) 113 and/or MDB 126). In one example, user endpoint device 141 may also retrain and update such MLM(s) based upon locally collected performance metrics. Accordingly, user endpoint device 141 may monitor its own current location (e.g., via Global Positioning System (GPS) information or locally provided information from a building or site), local conditions (e.g., its current movement speed, its current location within an enclosed building or structure, e.g., an elevator, a lower level such as a basement), and local access point performance metrics (e.g., performance metrics associated with a Wi-Fi access point versus a RAN access point).

At the airport 190, in one example, user endpoint device 141 can report locally detected performance metrics. For instance, user endpoint device 141 may report locally detected performance metrics to server(s) 112, or 125 via access point 195, base stations 117 and/or 118, wired links of a network of airport 190 (not shown), and so forth, and over one or more networks such as wireless access network 120, wireless access network 115, Internet 130, communication network 110, etc.

In one example, DB(s) 113 may contain machine learning model (MLM) database (DB) that may store various machine learning models for optimizing audio performance for a call. For instance, a first machine learning model may be for detecting and monitoring performance associated with a Wi-Fi access point, whereas a second machine learning model may be for detecting and monitoring performance associated with a RAN access point. In one example, there may be different machine learning models for different access point technologies.

In accordance with the present disclosure, optimizing audio performance for a call may be in accordance with one or more machine learning algorithms (MLAs), e.g., one or more trained machine learning models (MLMs). For instance, a machine learning algorithm (MLA), or machine learning model (MLM) trained via a MLA may be for detecting and monitoring performance associated with one or more types of access points. For instance, the MLA (or the trained MLM) may comprise a deep learning neural network, or deep neural network (DNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. Similarly, a regression-based model may be trained and used for prediction, such as linear regression, polynomial regression, ridge regression, lasso regression, etc. In one example, the MLM(s) may be trained at a network-based processing system (e.g., server(s) 125, server(s) 112, or the like).

In one example, an MLM for performance associated with a RAN access point may comprise a recurrent neural network (RNN), a long-short term memory (LSTM) neural network, or the like. For instance, RNNs and LSTMs may be trained on and make predictions with respect to time series data. In another example, an MLM for performance associated with a RAN access point may comprise a convolutional neural network (CNN) that is suitable for time series data, such as an AlexNet or WaveNet. In accordance with the present disclosure, MLA/MLM inputs may include locally detected performance metrics, locally detected conditions, and/or performance metrics received from a Master Database.

In one example, the present disclosure may apply a MLM in accordance with a “hybrid” MLA approach. For instance, such a “hybrid” approach may be distinguished for other techniques that utilize multiple MLMs such as “ensemble” approaches, bagging, etc. To illustrate, in a “hybrid” MLA approach, multiple MLMs may be used in which the output of one MLM may comprise an input to one or more other MLMs. In one example, each of the MLMs may be considered as a layer or module within an overall MLM. In other words, in such an example, one MLM may be composed of multiple components, which may also be MLMs, and which may be trained separately, or which may be trained collectively. For instance, an output of a neural network-based MLM (e.g., to detect one or more local conditions) may be an input to a binary classifier for determining whether to select a different access point technology for an audio call.

In one example, training data may be gathered from numerous test runs performed by various users, data provided by a network service provider, and so forth. For each test run, a label may be applied as to which access point technology was utilized for an audio call and/or for how long.

It should be noted that although FIG. 1 illustrates an example relating to airline travel, other examples may relate to travel by train, ship, bus, etc., which may have corresponding machine learning models (and machine learning algorithms for training such models). Similarly, different types of MLAs/MLMs may be used for different types of detected conditions or different use cases. For instance, a MLM/MLA accounting for adverse condition can be deployed when an adverse condition is detected. Alternatively, a MLM/MLA accounting for arrival on an airplane to a foreign jurisdiction can be deployed when a foreign wireless network or a foreign airport is detected.

The foregoing illustrates just one example of a system in which examples of the present disclosure for optimizing audio performance for a call, e.g., via a machine learning algorithm may operate. In addition, the foregoing is described in connection with just one example travel scenario and transit location. However, it will be appreciated that optimizing audio performance for a call for various other travel or roaming scenarios through various other transit locations and in connection with various modes of transport or travel may be facilitated via the system 100.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 125 may alternatively or additionally be performed by server(s) 112, and vice versa. In addition, although server(s) 112 and 125 are illustrated in the example of FIG. 1, in other, further, and different examples, the same or similar functions may be distributed among multiple other devices and/or systems within the communication network 110, wireless access network(s) 115 and/or 120, and/or the system 100 in general that may collectively provide various services in connection with examples of the present disclosure for optimizing audio performance for a call, e.g., via a machine learning algorithm. Additionally, devices that are illustrated and/or described as using one form of communication (such as a cellular or non-cellular wireless communications, wired communications, etc.) may alternatively or additionally utilize one or more other forms of communication. In one example, access point 195 may comprise a 5G internet gateway (e.g., a 5G Wi-Fi gateway) that may use Wi-Fi for wireless communication with endpoint devices and cellular communication (e.g., 5G and/or 4G/LTE, etc.) for connectivity to the network. Thus, for example, as illustrated in FIG. 1, access point 195 may alternatively or additionally be in communication with base station 117 of wireless access network 115. Thus, these and other modifications are all contemplated within the scope of the present disclosure.

In one example, the steps, functions, or operations of method 200 may be performed by a computing device or processing system, such as computing system 300 and/or hardware processor element 302 as described in connection with FIG. 3 below. For instance, the computing system 300 may represent any one or more components of the system 100 (e.g., user endpoint device 141) that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 300 may collectively function as a processing system. For illustrative purposes, the method 200 is described in greater detail below in connection with an example performed by a processing system. The method 200 begins in step 205 and may proceed to optional step 210, optional step 220, or step 230.

At optional step 210, the processing system detects one or more local conditions. For example, in an adverse environment use case, user endpoint device 141 may monitor its own current location (e.g., via Global Positioning System (GPS) information or locally provided information from a building or site), local conditions (e.g., its current movement speed, its current location within an enclosed building or structure, e.g., an elevator, a lower level such as a basement), and local access point performance metrics (e.g., performance metrics associated with a Wi-Fi access point versus a RAN access point). It should be noted that “detection” may include receiving local condition information from a local establishment, e.g., from an airport customer facing system, that provides flight status and airport location information. Alternatively, in a destination airport use case, user endpoint device 141 may detect a foreign wireless network or a foreign airport upon landing, e.g., when the user is allowed to turn on his or her smart phone while still situated within airplane 160. Thus, in one example, step 210 may include detecting at least one local condition at the location, where the at least one local condition may include a presence at a foreign jurisdiction of the user endpoint device (e.g., in contrast to a home jurisdiction of the user endpoint device), a presence of the user endpoint device at a particular type of transit location (e.g., a train station, an airport, etc.), and/or a presence of the user endpoint device within an enclosed structure, such as described above.

At optional step 220, the processing system may perform configuration and registration tasks. For example, in the adverse environment use case, user endpoint device 141 may execute one or more performance configurations, e.g., dynamic switching on the uplink of the standalone time division duplexing (TDD) band and the standalone TDD and frequency division duplexing (FDD) band, dynamic prioritization of certificate authority (CA), dynamic configuration pertaining to reference signal received power (RSRP)/reference signal received quality ((RSRQ), total bandwidth comparison of TDD MIMO (multiple input, multiple output) and FDD/TDD CA, selection of modulation and coding scheme (MCS) and the like. For example, in the destination airport use case, user endpoint device 141 may execute one or more configurations or registrations, e.g., update of latest known mapped cellular frequency numbers, Wi-Fi access point name and credentials, upload and synchronize with a Master Database for various access point information such as access point names and associated credentials, perform device registration with a local cellular network, perform targeted band scanning, select cell registration, device registration with cell, and the like.

In one example, optional step 220 may include performing at least one configuration task to configure at least one aspect of the user endpoint device, e.g., in accordance with/based upon the at least one local condition that is detected. Similarly, in one example, optional step 220 may alternatively or additionally include performing at least one registration task to register the user endpoint device with at least one communication network, e.g., in accordance with/based upon the at least one local condition that is detected. For instance, the registration may be with a cellular network and/or a network operator that provides access to a Wi-Fi network (which may be the same or different from the cellular network operator).

In step 230, the processing system may initiate a call, e.g., initiate an audio call via a user endpoint device. For example, a user 140 may attempt to make a call using endpoint device 141 to reach user endpoint device 151 of user 150. In other words, in one example, the processing system (e.g., of the user endpoint device) may initiate an audio call for the user endpoint device at the location. The audio call may be initiated by a user input via the user endpoint device, or may in response to an incoming call request (e.g., where the request may be received via any available access point type, but where the call may be established via a particular access point type to be selected by the processing system).

In step 240, the processing system may select one or more performance optimizations. For example, in one use case, processing system may select one particular type of access point technology from a plurality of access point types or technologies, e.g., a Wi-Fi access point versus a RAN access point. In the selecting process of step 240, the processing system may assess the performance of a plurality of available access point types or technologies for a local location, e.g., between an available Wi-Fi access point and an available RAN access point with respect to the user endpoint device. For example, the user is currently at an airport and the user endpoint device can utilize an available Wi-Fi access point or an available RAN access point. The processing system may select one of the available Wi-Fi access point or the available RAN access point based on current locally detected performance metrics at a particular location. Alternatively, the processing system may select one of the available Wi-Fi access point or the available RAN access point based on information obtained from a Master Database that may provide aggregated performance metrics reported by a plurality of user endpoint devices over an extended period of time (e.g., the last hour, the last 12 hours, the last week, the last month, etc.). Thus, in one example, step 240 may include selecting a wireless access point type from among a plurality of wireless access point types for the audio call based on at least one of: performance metrics collected by the user endpoint device at the location or performance metrics for the location obtained by the user endpoint device from a remote database. In addition, in one example, step 240 may further include implementing (e.g., by the processing system) the audio call via the wireless access point type that is selected. In one example, the plurality of wireless access point types may include at least a cellular access point type and a non-cellular wireless access point type.

In one example, the performance metrics collected by the user endpoint device at the location may include at least one of: first performance metrics for a first wireless access point type at the location or second performance metrics for a second wireless access point type at the location. In addition, in one example, the performance metrics for the location obtained by the user endpoint device from the remote database may include at least one of: third performance metrics for the first wireless access point type at the location or fourth performance metrics for the second wireless access point type at the location. In addition, although the terms, “first,” “second,” “third,” etc., may be used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” does not imply a particular number of those items corresponding to those numerical values. In addition, the use of the term “third” for example, does not imply a specific sequence, temporal relationship, or precedence with respect to a “first” and/or a “second” of a particular type of item, unless otherwise indicated.

As noted above, the performance metrics collected by the user endpoint device at the location may include measurements of at least one of: packet loss, latency, or jitter for at least one of the first wireless access point type or the second access point type (e.g., current measurements by the endpoint device or previous measurements by the endpoint device at the same location for one or both access point types). Similarly, the performance metrics for the location obtained by the user endpoint device from the remote database include measurements of at least one of: a packet loss, a latency, or a jitter for at least one of the first wireless access point type or the second access point type (e.g., previous measurements by other endpoint device(s) at the same location for one or both access point types).

In one embodiment, a MLA/AIA deployed local to the endpoint device is utilized to make the selection based on locally collected performance metrics and/or performance metrics received from the Master Database (broadly a remote database with respect to the user endpoint device, i.e., external to the user endpoint device). Once the selection is made, the processing system implements the audio call using the selected performance optimization. It should be noted that although the present disclosure discusses the selection of an access point technology between a Wi-Fi access point versus a RAN access point, the present disclosure is not limited to only these two access point types. The present approach can be applied to any other types of access point technologies.

Thus, in one example, the selecting of step 240 may be in accordance with at least one machine learning model (MLM). For instance, the selecting may include applying the at least one of the performance metrics collected by the user endpoint device at the location or the performance metrics for the location obtained by the user endpoint device from the remote database as inputs to the at least one MLM. In one example, the selecting of step 240 may further include obtaining at least one output of the at least one MLM. For instance, the output may comprise at least one of: a predicted packet loss, a predicted latency, or a predicted jitter for at least one of the first wireless access point type or the second access point type at the location. In one example, step 240 may further include comparing at least one prediction to at least one threshold and/or comparing two or more predictions to each other to decide which wireless access point type to select. in one example, the at least one MLM may comprise a time series prediction model that looks at previous performance metrics and/or current (most recent) performance metrics, and then makes predictions for near future time periods (e.g., during the audio call to be established). Alternatively, or in addition, in one example, step 240 may include obtaining at least one output of the at least one MLM. For instance, in one example, the at least one output may comprise a selection of the wireless access point type from among the plurality of wireless access point types. For instance, the at least one MLM may comprise an ensemble model where a first component MLM takes outputs of one or more of: predicted packet loss, a predicted latency, or a predicted jitter for a first wireless access point type and second wireless access point type (e.g., from two other component MLMs) and then makes a decision based on all of these as inputs. However, in another example, a single MLM may take all of the performance metric inputs, and may generate an output (e.g., a binary classifier or multi-class classifier, a decision tree, etc.). In one example, the at least one MLM may be selected based upon the at least one local condition that is detected. For instance, the at least one MLM may be associated with/designated for a specific local condition, e.g., the MLM is specifically trained and deployed for use in connection with the at least one local condition, where one or more other MLMs may be trained and may be available for use in connection with other local conditions.

In optional step 250, the processing system determines whether the audio call has ended. If the query is positively determined, method 200 ends in step 295. If the query is negatively determined, method 200 proceeds to step 260.

In optional step 260, the processing system monitors or collects the performance quality measurements of the selected performance optimization, e.g., monitoring or collecting metrics pertaining to the selected access point type being used for the audio call. In other words, the processing system may collect (e.g., measure) performance quality measurements for the audio call via the wireless access point type that is selected. In one example, optional step 260 may further include transmitting the performance quality measurements to the remote database, e.g., where the performance quality measurements may be stored in the remote database as additional performance metrics for the wireless access point type at the location.

In optional step 270, the processing system determines whether the audio call should continue to use the selected performance optimization, e.g., continue in using the selected access point type. For example, if the selected access point type is still the most appropriate access point type then the query is positively determined and method 200 proceeds to step 260 where the processing system continues to monitor or collect the performance quality measurements of the selected performance optimization. If the query is negatively determined, method 200 proceeds to step 240, where the processing system may select a different performance optimization, e.g., select a different type of access point. Thus, for example, returning to step 240, the processing system may select a different wireless access point type from among the plurality of wireless access point types for the audio call in accordance with the performance quality measurements and may migrate the call to the different wireless access point type at the location. In one example, the selecting of the different wireless access point type may be in accordance with at least one MLM, which may be the same or different from the at least one MLM applied in a prior instance of performing step 240.

As noted above, at optional step 250, the processing system may determine whether the audio call has ended. If the query is positively determined, the method 200 may proceed to step 295. At step 295, the method 200 ends.

It should be noted that method 200 may be expanded to include additional steps, or may be modified to replace steps with different steps, to combine steps, to omit steps, to perform steps in a different order, and so forth. For example, the method 200 may be expanded to include collecting the first and/or the second performance metrics at the location (e.g., from prior visits to the same location and/or otherwise in advance of step 230, and so forth). In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing system 300 (e.g., a computing device or processing system) specifically programmed to perform the functions described herein. For example, any one or more components, devices, and/or systems illustrated in FIG. 1 or described in connection with FIGS. 1-2, may be implemented as the computing system 300. As depicted in FIG. 3, the computing system 300 comprises a hardware processor element 302 (e.g., comprising one or more hardware processors, which may include one or more microprocessor(s), one or more central processing units (CPUs), and/or the like, where the hardware processor element 302 may also represent one example of a “processing system” as referred to herein), a memory 304, (e.g., random access memory (RAM), read only memory (ROM), a disk drive, an optical drive, a magnetic drive, and/or a Universal Serial Bus (USB) drive), a module 305 for optimizing audio performance for a call, e.g., via a machine learning algorithm, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 302 is shown, the computing system 300 may employ a plurality of hardware processor elements. Furthermore, although only one computing device is shown in FIG. 3, if the method(s) as discussed above is implemented in a distributed or parallel manner for a particular illustrative example, e.g., the steps of the above method(s) or the entire method(s) are implemented across multiple or parallel computing devices, then the computing system 300 of FIG. 3 may represent each of those multiple or parallel computing devices. Furthermore, one or more hardware processor elements (e.g., hardware processor element 302) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 302 can also be configured or programmed to cause other devices to perform one or more operations as discussed above. In other words, the hardware processor element 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 305 for optimizing audio performance for a call, e.g., via a machine learning algorithm (e.g., a software program comprising computer-executable instructions) can be loaded into memory 304 and executed by hardware processor element 302 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 302) executing the computer-readable instructions relating to the above described method(s) can be perceived as a programmed processor or a specialized processor. As such, the present module 305 for optimizing audio performance for a call, e.g., via a machine learning algorithm (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
initiating, by a processing system of a user endpoint device, the processing system including at least one processor, an audio call for the user endpoint device at a location;
selecting, by the processing system, a wireless access point type from among a plurality of wireless access point types for the audio call based on at least one of: performance metrics collected by the user endpoint device at the location or performance metrics for the location obtained by the user endpoint device from a remote database; and
implementing, by the processing system, the audio call via the wireless access point type that is selected.

2. The method of claim 1, wherein the performance metrics collected by the user endpoint device at the location include at least one of: first performance metrics for a first wireless access point type at the location or second performance metrics for a second wireless access point type at the location, and wherein the performance metrics for the location obtained by the user endpoint device from the remote database include at least one of: third performance metrics for the first wireless access point type at the location or fourth performance metrics for the second wireless access point type at the location.

3. The method of claim 1, wherein the plurality of wireless access point types includes at least: a cellular access point type and a non-cellular wireless access point type.

4. The method of claim 2, wherein the performance metrics collected by the user endpoint device at the location include measurements of at least one of: a packet loss, a latency, or a jitter for at least one of: the first wireless access point type or the second wireless access point type.

5. The method of claim 2, wherein the performance metrics for the location obtained by the user endpoint device from the remote database include measurements of at least one of: a packet loss, a latency, or a jitter for at least one of: the first wireless access point type or the second wireless access point type.

6. The method of claim 2, wherein the selecting is in accordance with at least one machine learning model.

7. The method of claim 6, wherein the selecting comprises:
applying the at least one of: the performance metrics collected by the user endpoint device at the location or the performance metrics for the location obtained by the user endpoint device from the remote database as inputs to the at least one machine learning model.

8. The method of claim 7, wherein the selecting further comprises:
obtaining at least one output of the at least one machine learning model, wherein the at least one output comprises at least one of: a predicted packet loss, a predicted latency, or a predicted jitter for at least one of: the first wireless access point type or the second wireless access point type.

9. The method of claim 7, wherein the selecting further comprises:
obtaining at least one output of the at least one machine learning model, wherein the at least one output comprises a selection of the wireless access point type from among the plurality of wireless access point types.

10. The method of claim 1, further comprising:
detecting at least one local condition at the location.

11. The method of claim 10, wherein the at least one local condition comprises at least one of:
a presence at a foreign jurisdiction of the user endpoint device;
a presence at a particular type of transit location; or
a presence within an enclosed structure.

12. The method of claim 10, further comprising:
selecting the at least one machine learning model based upon the at least one local condition that is detected.

13. The method of claim 10, further comprising:
performing at least one configuration task to configure at least one aspect of the user endpoint device based upon the at least one local condition that is detected.

14. The method of claim 10, further comprising:
performing at least one registration task to register the user endpoint device with at least one communication network based upon the at least one local condition that is detected.

15. The method of claim 1, further comprising:
collecting performance quality measurements for the audio call via the wireless access point type that is selected.

16. The method of claim 15, further comprising:
transmitting the performance quality measurements to the remote database, wherein the performance quality measurements are stored in the remote database as additional performance metrics for the wireless access point type at the location.

17. The method of claim 15, further comprising:
selecting a different wireless access point type from among the plurality of wireless access point types for the audio call in accordance with the performance quality measurements; and
migrating the audio call to the different wireless access point type.

18. The method of claim 17, wherein the selecting the different wireless access point type is in accordance with at least one machine learning model.

19. A non-transitory computer-readable medium storing instructions which, when executed by a processing system of a user endpoint device including at least one processor, cause the processing system to perform operations, the operations comprising:
initiating an audio call for the user endpoint device at a location;
selecting a wireless access point type from among a plurality of wireless access point types for the audio call based on at least one of: performance metrics collected by the user endpoint device at the location or performance metrics for the location obtained by the user endpoint device from a remote database; and
implementing the audio call via the wireless access point type that is selected.

20. An apparatus comprising:
a processing system including at least one processor of a user endpoint device; and
a computer-readable medium storing instructions which, when executed by the processing system, cause the processing system to perform operations, the operations comprising:
initiating an audio call for the user endpoint device at a location;
selecting a wireless access point type from among a plurality of wireless access point types for the audio call based on at least one of:
performance metrics collected by the user endpoint device at the location or performance metrics for the location obtained by the user endpoint device from a remote database; and
implementing the audio call via the wireless access point type that is selected.
